(19) United States
(12) Patent Application Publication
(10) Pub. No.: US 2003/0145093 A1
(43) Pub. Date: Jul. 31, 2003

(54) System and method for peer-to-peer file exchange mechanism from multiple sources

(76) Inventors: Elan Oren, Yehuda (IL); Igor Magazinik, Yehuda (IL)

Correspondence Address: Anthony Castorina, G E Ehrlich (1995) Ltd, Suite 207, 2001 Jefferson Davis Highway, Arlington, VA, 22202, US

(21) Appl. No.: 10/275,865

(22) PCT Filed:
(86) PCT No.: PCT/IB02/02113

(51) Int. Cl. G06F 15/16

(52) U.S. Cl. 709/229; 709/219

(57) ABSTRACT

A system and a method for file exchanges between peer computational devices connected through a network, for peer-to-peer file exchanges. The present invention enables the peer devices to retrieve information about the location of files of interest from a central location authority, which features a centralized database. Therefore, the system and method of the present invention features a mixture of client/server and peer-to-peer communication functionality, in which the bandwidth-intensive, computationally heavy process of retrieving files is performed locally, through a peer-to-peer process; while the computationally lighter and less bandwidth-intensive process of determining the location of any particular file is performed locally. The system of the present invention features a plurality of distributed, decentralized file provision computational devices, which are peer devices and which optionally operate a client module, and a central location authority, for locating files of interest between computational devices connected to the network through communication with the client module. These files are preferably tagged with a file identifier, while each peer device has an associated user identifier. Therefore, files can be managed within the system of the present invention, and can even be blocked from being allowed into the system of the present invention. In addition, the action of users can optionally be controlled by controlling the activities of peer devices. According to preferred embodiments of the present invention, multiple peer devices are considered in order determine from which peer device the file should be downloaded.

### FIELD OF THE INVENTION

The present invention relates to a system and a method for a peer-to-peer file exchange mechanism, and in particular, for such a mechanism which is suitable for a network having limited bandwidth and/or limited reliability.

### BACKGROUND OF THE INVENTION

The Internet has enabled computer users all over the world to interact and communicate electronically. One particularly popular mode for communication is through Web pages, which collectively form the World Wide Web. Web pages are useful for displaying text and graphics, and even animation, video data and audio data. Data exchanges through the World Wide Web are limited to the client/server model, in which a first computational device acts as the server, for providing data to the second computational device, which is therefore the client. This model is useful if the server has much greater capabilities to provide data than the client, as for example for a centralized server on the World Wide Web, which is typically adapted to provide data to multiple clients simultaneously. However, this model is less useful for data exchanges between networks of distributed computational devices, in which these devices are similar in their bandwidth and data provision capabilities, such that the devices are “peers”.

In order to overcome this problem, “peer-to-peer” communication mechanisms have been developed. Examples of peer-to-peer communication include instant messaging services between users, such as ICQ for example. Further developments have enabled peer-to-peer file exchange mechanisms to be created, perhaps the most famous example of which is Napster (www.napster.com as of Feb. 19, 2001). These file exchange mechanisms enable users to exchange files directly between their computational devices, such that the users do not need to download files from a centralized server. However, the current disadvantage of these peer-to-peer file exchange mechanisms is that they may place a heavy computational burden on the individual computational devices and/or on the network which connects these computational devices. Furthermore, if these systems have problems with reliability of services, such as reliability of the network for example, there are no currently available solutions to the loss of the ability to download a file when a particular server source is temporarily or permanently unable to connect to the network.

### SUMMARY OF THE INVENTION

The background art does not teach or suggest a system and method for sharing files between peer devices in which access of users is controlled. Furthermore, the background art also does not teach or suggest such a system or method in which the files have separate unique file identifiers, such that the files can be controlled and managed within the system, and can even be blocked from entering the system. Also, the present invention enables separate billing events to be associated with each file transfer according to the unique file identifier.

There is therefore an unmet need for, and it would be useful to have, a system and method for peer-to-peer file transfer in which each peer device has a separate, unique user identifier, while each file has a separate, unique file identifier, such that both the files and the actions of the users within the system can optionally be individually controlled.

The present invention provides these desired features through a system and a method for file exchanges between peer computational devices connected through a network, for peer-to-peer file exchanges. The present invention enables the peer devices to retrieve information about the location of files of interest from a central location authority, which features a centralized database. Therefore, the system and method of the present invention features a mixture of client/server and peer-to-peer communication functionality, in which the bandwidth-intensive, computationally heavy process of retrieving files is performed locally, through a peer-to-peer process; while the computationally lighter and less bandwidth-intensive process of searching for a particular file and then determining the location of that file is performed locally.

The system of the present invention features a plurality of distributed, decentralized file provision computational devices, which are peer devices and which optionally operate a client module, and a central location authority, for locating files of interest between computational devices connected to the network through communication with the client module. These files are preferably tagged with a file identifier, while each peer device has an associated user identifier. The file identifier is optionally and preferably created from the file itself according to a cryptographic method, such as MD5 for example. Therefore, files can be managed within the system of the present invention, and can even be blocked from being allowed into the system of the present invention. In addition, the action of users can optionally be controlled by controlling the activities of peer devices.

According to preferred embodiments of the present invention, multiple peer devices are considered in order determine from which peer device the file should be downloaded.

The present invention has the advantages over the background art of providing excellent performance, both in terms of the response time and the number of concurrently or simultaneously supported users. In addition, the present invention is scalable, thereby permitting the capacity to be increased incrementally, preferably through the division of the system into a plurality of separate, scalable components. Also, most of the components of the present invention can operate in parallel, both to support more users and to increase redundancy within the system.

According to the present invention, there is provided a method for file transfer between a plurality of peer devices connected through a network, the method comprising the stages of: (a) associating each peer device with a unique peer device identifier; (b) associating each file with a unique file identifier; (c) requesting a particular file by the peer device according to the unique file identifier; (d) controlling access by a particular peer device to the network according to the unique peer device identifier; and (e) controlling access of the file to the network according to the unique file identifier.

According to another embodiment of the present invention, there is provided a system for controlled peer-to-peer file transfer through a network, comprising: (a) a plurality of peer devices connected to the network, each peer device having a unique peer identifier; and (b) a central authority for holding a list of available files and for storing the peer identifiers, the central authority receiving a request for a file from a peer device and determining whether the peer device should receive the file, such that if the peer device should receive the file, the central authority sends a peer identifier of a peer device storing the file to the requesting peer device.

Hereinafter, the term “network” refers to a connection between any two or more computational devices which permits the transmission of data.

Hereinafter, the term “computational device” includes, but is not limited to, computers having any known and available operating system, or any device which is capable of data processing, including but not limited to: laptops, hand-held computers, PDA (personal data assistant) devices, cellular telephones, any type of WAP (wireless application protocol) enabled device, and computers of any sort which can be connected to a network as previously defined and which have an operating system.

Hereinafter, the term “file” is used to indicate any unit of data, whether as a discrete, separate unit of data, or alternatively as part of a data stream.

For the present invention, a software application could be written in substantially any suitable programming language, which could easily be selected by one of ordinary skill in the art. The programming language chosen should be compatible with the computational device according to which the software application is executed. Examples of suitable programming languages include, but are not limited to, C, C++ and Java.

In addition, the present invention could be implemented as software, firmware or hardware, or as a combination thereof For any of these implementations, the functional stages performed by the method could be described as a plurality of instructions performed by a data processor.

### BRIEF DESCRIPTION OF THE DRAWINGS

The invention is herein described, by way of example only, with reference to the accompanying drawings, wherein:

FIG. 1 is a schematic block diagram of an exemplary system according to the present invention; and

FIG. 2 is a flowchart of an illustrative method for operating the exemplary system of FIG. 1.

### DESCRIPTION OF THE PREFERRED EMBODIMENTS

The present invention is of a system and a method for file exchanges between peer computational devices connected through a network, for peer-to-peer file exchanges. The present invention enables the peer devices to retrieve information about the location of files of interest from a central location authority, which features a centralized database. Therefore, the system and method of the present invention features a mixture of client/server and peer-to-peer communication functionality, in which the bandwidth-intensive, computationally heavy process of retrieving files is performed locally, through a peer-to-peer process; while the computationally lighter and less bandwidth-intensive process of determining the location of any particular file is performed locally.

In addition, the present invention is scalable, thereby permitting the capacity to be increased incrementally, preferably through the division of the system into a plurality of separate, scalable components. Also, most of the components of the present invention can operate in parallel, both to support more users and to increase redundancy within the system.

The system of the present invention features a plurality of distributed, decentralized file provision computational devices, which are peer devices and which optionally operate a client module, and a central location authority, for locating files of interest between computational devices connected to the network through communication with the client module.

The client module optionally features two separate types of functionality. According to a first type of functionality, the client module communicates with the central location authority in order to locate a file of interest which is stored at a peer device. According to a second type of functionality, the client module preferably then requests the desired file from the peer device by communicating with the client module of that peer device. Optionally, the files which are exchanged are signed with a digital signature by the client module, both for security reasons (in order for the recipient peer device to securely receive the requested file) and optionally also in order to block the transfer of illegal or unauthorized content.

More preferably, the client module selects a plurality of peer devices for downloading the file simultaneously. Most preferably, each peer device selected for downloading is connected to the same ISP (Internet Service Provider) as the peer device which is requesting the particular file for downloading.

Optionally, the unique file identifier is a unique file pointer, or “URL”, featuring at least a file signature for the particular file. Preferably, the unique file pointer also features identifiers for particular types of rules, for example in order to be able to determine which user(s) can have access to the file. More preferably, the unique file pointer is presented to the user through a GUI (graphical user interface) presented by the client module, such that when the user “clicks on” or otherwise selects the file with a mouse or other pointing device, the file is automatically added to the “download list” of the user. Alternatively, if the pointer is presented to the user through a GUI other than that of the client module, the client module is automatically activated. If the peer device does not have the client module installed, preferably the user is presented with the option to download such a client module.

The central location authority preferably has three layers: a front end layer for communication between the central location authority and the plurality of peer devices; one or more service servers; and the centralized database.

The front end more preferably features a plurality of servers for direct communication with the peer devices. One of the plurality of servers is optionally and preferably a central server, which concentrates information about the online users, or at least about the peer devices in the network. Central server communicates with the peer devices and updates the online user list and/or the peer device list. Optionally and more preferably, the central server is also in communication with a plurality of user services, which most preferably maintain the connection between the central location authority and the peer devices This connection is more preferably maintained by using periodic keep-alive messages between the peer device and the application server. User servers may also optionally handle certain requests from the peer devices, while redirecting other requests to relevant backend servers.

Examples of requests handled by the user servers include, but are not limited to, requests regarding user status such as online, offline or away (offline for an extended period of time);

their connection information (IP address and Port Number), connection type, etc. The user server also serves as a gateway while sending messages from client module to client module (when direct connection is impossible). Also the user server helps the client module to choose proper port for uploading (by trying different ports in order to find an available port).

Other types of requests are preferably not handled by the user server. For example, searches are preferably redirected to the search engine, or alternatively to a search engine which is outside the system. File information requests are preferably redirected to the Slice Server. Requests for download sources, which are the peer devices of users who own this file and are available at this moment, are preferably redirected to the Slice Server.

The central server is optionally and more preferably in communication with these user servers in order to support communication between users having peer devices which are connected to two different user servers through the network. A load balancer is preferably used in order to balance the communication load between different user servers, for distributing the peer devices between the user servers. When a user sends the first connection request to the central location authority, the central server preferably directs the peer device to connect to a certain user server as part of this load balancing process. The load balancer may optionally be implemented as a separate server within central location authority, or alternatively may be implemented as a process which is operated by the central server.

In addition, the central location authority may contain a plurality of service servers, which are active whenever a user performs a request. Therefore the response and the availability of such servers are mostly influenced by the number of parallel components. The ability to operate some servers in parallel increases the availability, such that preferably a plurality of each of type of service server is contained within the central location authority.

One type of service server is the search engine, which is a server that runs a search application. The search is performed over index files that contain only the keyword and some related information. Once the results have been obtained, optionally and preferably the search engine obtains further details from the slice server.

The slice servers preferably maintain a copy of the record details from the centralized database. There are preferably several slice-servers, each of which more preferably maintains a separate part of the original centralized database. Most preferably, the database is divided into separate parts according to ranges of files, such that each slice server would maintain a particular range of files, for example for greater scalability. At the very minimum, each slice server preferably stores information or details about the files, as well as about one or more users (owners) who have those files stored on their peer device. This structure enables the slice servers, and hence the portions of the distributed database, to work in parallel. Optionally and more preferably, these slice servers are limited to serving the most popular file-oriented requests, such as file details, file owners, etc.

The database backend preferably features a database server, which stores all of the shared file details and owners, as well as all the required information about registered users. The database is optionally based on Oracle.

According to preferred features of the present invention, the front layer also features at least one, and more preferably a plurality of, Web servers for serving Web pages. These Web pages may be static, but most preferably also feature dynamic Web page assembly functionality. There should also be the option of constructing a search through these Web servers.

According to other preferred features of the present invention, the service servers also preferably include a business server, for handling such business related matters as billing users for their interactions with the central location authority. The business server also optionally acts as an authentication server as well. For the latter functions, the business server preferably contains all the authorization and policy information for each user. Such a business server may also optionally and more preferably be used to determine the scope of services provided to any particular user through the peer device. For example, the user may only receive answers from the search engine which are within the scope for that user. If a user has a gold membership, for instance, any record could be made available for downloading, while with normal membership, some sort of micro-payment setting and/or registration may optionally be required from the user.

According to preferred embodiments of the present invention, multiple peer devices are considered in order determine from which peer device the file should be downloaded. Preferably, the user server determines a list of suitable peer devices according to a file identifier for the file. More preferably, only those peer devices which are currently connected to a network such as the Internet, or “on-line”, are included. Most preferably, only those peer devices which are connected to the same ISP (Internet Service Provider) of the requesting peer device are considered.

Once the client module of the user device has selected one or more suitable locations for downloading the file, a connection is opened to these peer device (s). Most preferably, the file is downloaded simultaneously from a plurality of different peer devices. The file is preferably logically divided into small chunks, each of which is preferably an optimal size for a single “send” during a TCP/IP session, for downloading. More preferably, the chunks are signed, in order to be able to verify the authenticity and intactness of the file after downloading. The size of the logical chunks into which the file is to be divided is preferably determined by the peer device which is downloading the file. Optionally, the logical chunks may be any requested size. The peer device which is downloading the file then preferably requests specific chunks by specifying the physical block in the file, according to the offset of the block start and the length of the chunk. The chunk is then more preferably sent to the downloading peer device in a separate message.

If the connection between the client module (on the user device) and one of the peer device(s) is broken, optionally and preferably the client module attempts to reestablish the connection with another peer device from the list of such devices which hold the file. If there is no other peer device in the list, optionally the download is considered to be “queued” and more preferably resumes from the initial downloading stage, most preferably after a given period of time has elapsed.

The principles and operation of the present invention may be better understood with reference to the drawings and the accompanying description.

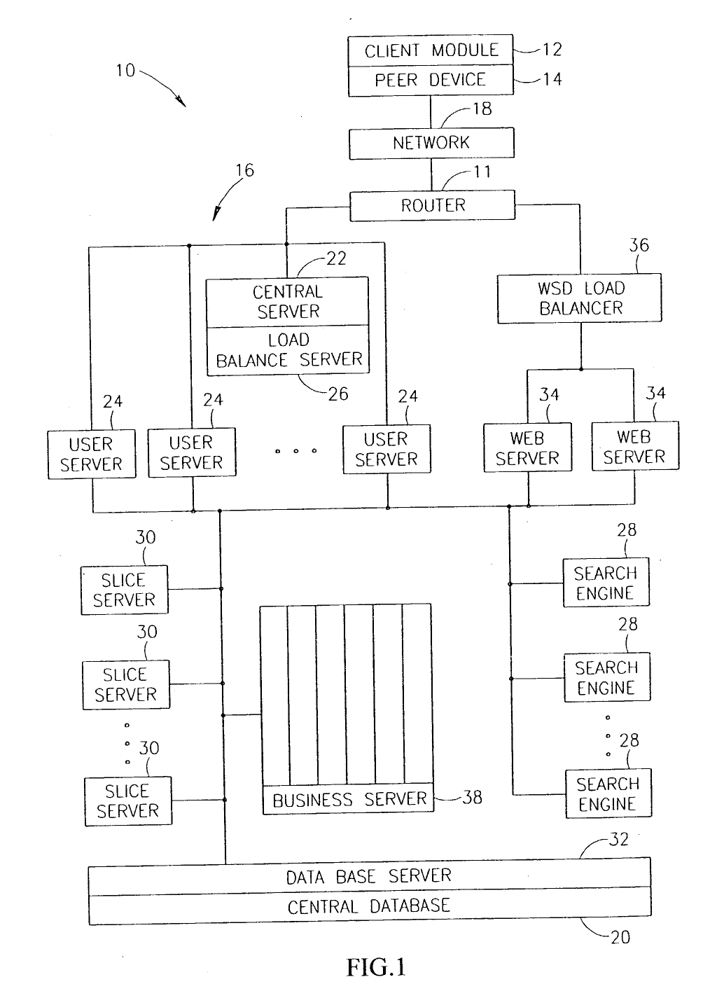

Referring now to the drawings, FIG. 1 is a schematic block diagram of a system according to the present invention. As shown, a system 10 features a plurality of peer devices 12, which are distributed, decentralized file provision computational devices. Each peer device 12 optionally and preferably operates a client module 14, and is in communication with a central location authority 16, for locating files of interest between peer devices 12 connected to a network 18. Network 18 could optionally be the Internet for example. Client module 14 is then used to retrieve the file from a particular peer device 12, and/or to transmit such a file to a requesting peer device 12. Thus, the user can browse shared files from other users of system 10. This information can be obtained directly from client module 14 of the user or alternatively from one or more servers at central location authority 18. However, optionally each file has a separate file identifier, and each peer device 12 optionally has a separate peer device identifier, such that access of the file and/or peer device 12 to system 10 may optionally and preferably be controlled and/or restricted, or at least managed.

Central location authority 16 preferably has three layers: a front end layer for communication between central location authority 16 and the plurality of peer devices 12; one or more service servers; and a centralized database 20.

The front end more preferably features a plurality of servers for direct communication with peer devices 12. One of the plurality of servers is optionally and preferably a central server 22, which concentrates information about the online users, or at least about peer devices 12 connected to network 18. Central server 22 communicates with peer devices 12 and updates the online user list and/or the peer device list.

Optionally and more preferably, central server 22 is also in communication with a plurality of user servers 24, which most preferably maintain the connection between central location authority 16 and peer devices 12. This connection is more preferably maintained by using periodic keep-alive messages between each peer device 12 and a particular user server 24.

User servers 24 may also optionally handle certain requests from peer devices 12, while redirecting other requests to relevant backend servers.

Central server 22 is optionally and more preferably in communication with user servers 24 in order to support communication between users having peer devices 12 which are connected to two different user servers 24 through network 18. A load balancer 26 is preferably used in order to balance the communication load between different user servers 24, for distributing peer devices 12 between user servers 24. When a user sends the first connection request to central location authority 16, central server 22 preferably directs peer device 12 to connect to a certain user server 24 as part of this load balancing process. Load balancer 26 may optionally be implemented as a separate server within central location authority 16, or alternatively may be implemented as a process which is operated by central server 22.

In addition, central location authority 16 may contain a plurality of service servers, which are active whenever a user performs a request. One type of service server is a search engine 28, which is a server that runs a search application and of which a plurality are preferably contained within central location authority 16. The search is performed over index files that contain only the keyword and some related information Once the results have been obtained, optionally and preferably search engine 28 obtains further details from one of a plurality of slice servers 30.

Slice servers 30 preferably maintain a copy of the record details from centralized database 20. There are preferably a plurality of separate slice servers 30, each of which more preferably maintains a separate part of centralized database 20. This structure enables slice servers 30, and hence the portions of the distributed database 20, to work in parallel. Optionally and more preferably, slice servers 30 are limited to serving the most popular file-oriented requests, such as file details, file owners, etc.

Central location authority 16 also optionally and preferably features a database backend, which more preferably features a database server 32 for storing all of the shared file details and owners, as well as all the required information about registered users. Centralized database 20 is optionally based on Oracle.

According to preferred features of the present invention, client module 14 optionally features two separate types of functionality. According to a first type of functionality, client module 14 communicates with central location authority 16 in order to locate a file of interest which is stored at a peer device 12. According to a second type of functionality, client module 14 preferably then requests the desired file from peer device 12 by communicating with client module 14 of that peer device 12. Preferably, the user is able to view files which have been requested with a file view function, which also enables the user to manage upload/download status for sending/retrieving files from another peer device 12. In addition, the user is optionally and more preferably able to add/cancel/postpone downloading and uploading of files between other peer devices 12.

According to preferred embodiments of the present invention, client module 14 is able to download a file from several peer devices 12 at the same time. Therefore, even if one peer device 12 becomes disconnected, the download is not stopped, such that files are downloaded faster. In addition, accessibility of files may optionally be improved by organizing all data held in client modules 14 in a hierarchical tree, such that security equivalencies/ allowances may optionally be set in the form of an organization structure.

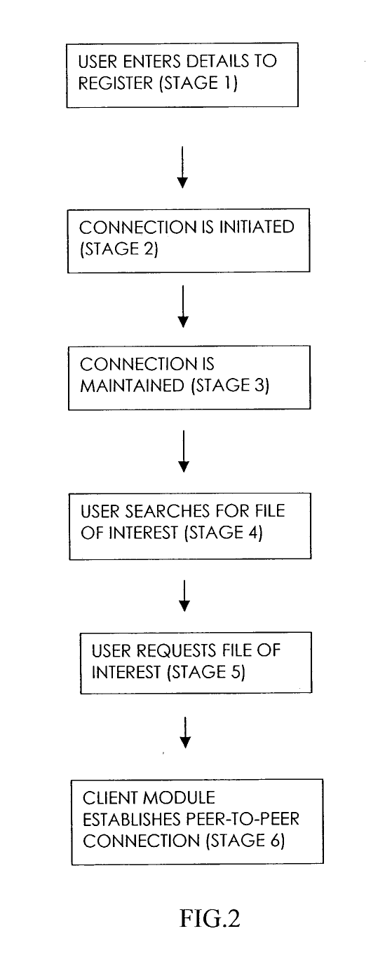

Optionally, the files which are exchanged are signed with a digital signature by client module 14, both for security reasons (in order for the recipient peer device 12 to securely receive the requested file) and optionally also in order to block the transfer of illegal or unauthorized content. The operation of client module 14 with central location authority 18 and other peer devices 12 is described with regard to the exemplary method of FIG. 2 below.

According to preferred features of the present invention, the front layer of central location authority also features at least one, and more preferably a plurality of, Web servers 34 for serving Web pages. These Web paged may be static, but most preferably also feature dynamic Web page assembly functionality. The load between Web servers 34 is optionally and preferably distributed with a Web load balancer 36. Such Web servers 34 may be used to augment the functionality provided through peer-to-peer file transfer in system 10.

Each Web server 34 could optionally provide such features as file search and browse functions; message boards and communities; user support; and directory listings. The Web site provided by Web server 34 is preferably used as an information center for a community of peer devices 12, for example in order to permit users to add information about other users to their contact list simply by clicking their name.

Optionally, different “skins”, or user interface styles or displays, can be downloaded to peer device 12 from Web server 34 in order to personalize and customize the appearance and functions of client module 14. Also optionally, tools such as recommended software programs could be obtained from Web server 34.

According to other preferred features of the present invention, central location authority 16 also preferably includes a business server 38, for handling such business related matters as billing users for their interactions with central location authority 16. Business server 38 also optionally acts as an authentication server as well. For the latter functions, business server 38 preferably contains all the authorization and policy information for each user. Such a business server 38 may also optionally and more preferably be used to determine the scope of services provided to any particular user through peer device 12. For example, the user may only receive answers from search engine 28 which are within the scope for that user. If a user has a gold membership, for instance, any record could be made available for downloading, while with normal membership, some sort of micro-payment setting and/or registration may optionally be required from the user.

Since each file which is transferred is preferably uniquely identified, as described in greater detail below with regard to FIG. 2, business server 38 is able to optionally charge a fee for each transaction through system 10. Client module 14 preferably notifies business server 38 of local billing events.

FIG. 2 is a flowchart of an exemplary method according to the present invention for operating the system of FIG. 1. The method preferably proceeds according to a number of different stages.

In the first stage, registration, the user enters some details to the central location authority. This stage is preferably required the first time that the user requests information about a file from the central location authority and/or attempts to download the client module itself. More preferably, the user also receives a user identifier (user ID) from the system.

In the next stage, a connection is initiated. When a user connects to the central location authority, the client module of the peer device sends and receives data to establish the connection between the client module and the user server. The client module also preferably obtains several session-oriented variables from the user server.

Next, the connection is maintained, by having the client module send a keep-alive message to check the connection, preferably every few hundred seconds. Such connection maintenance also enables the system to maintain some functionality when the peer device is located behind a firewall. More preferably, with regard to functionality in the presence of a firewall, a direct connection cannot always be established between the peer devices. To solve this problem, preferably the client module of the first peer device sends a special message to the client module of the second peer device, through the User Server, with a download request. When the client module of the second peer device receives this message, it makes the connection to the first peer device itself.

In the next stage, the user decides to search for a file of interest. After setting a search query in the search page at the client module, this query is sent to the user server, and thence is preferably sent to the search engine. If there are results, those results are sent to the peer device for display to the user page by page, through the client module. The user server also preferably obtains necessary file details from the slice server before sending them to the peer device of the requesting user.

Once the user has found a file of interest, the user then preferably asks the user server for the location of one or more download sources (peer devices storing this file), and then decides to download it to the peer device of the user from one such download source. In order to download a file, the user selects this file and requests a download. As a response the user receives information about some of the online owners who have this file (if any). This list is part of the list of the owners who are currently on-line, and is preferably refreshed randomly.

The client module then tries to establish a connection with each other peer device separately. The procedure of receiving a list of potential download sources and initiating the download connection is performed every time that there is a need to resume the download connection, for example, if the connection is unsuccessful and/or the download process is interrupted.

Optionally, the client module may use a plurality or even all of these download sources simultaneously, both for greater reliability and to increase the rate of data transfer.

According to optional but particularly preferred embodiments of the present invention, the actual downloading process is performed as follows. First, the user submits a request for the file or other download unit to the user server through the client module, by transmitting the file identifier as obtained from the previously described search results to the user server, in order to start downloading. The file identifier is then used to determine at least one, and preferably all, currently available “locations”, or peer devices, for specific file. More preferably, only those peer devices which are currently connected to a network such as the Internet, or “on-line”, are included.

The client module receives a list of available locations currently holding this file. This list preferably includes a set of data such a peer device holding the file, including but not limited to, IP address, uploading port number, type of connection, limit of allowed uploads and/or downloads, current number of uploads being performed, etc.

Next, preferably based on data received from the user server, the client module then selects several suitable locations for downloading the file. The client module then opens a connection to them. This process may optionally use several kinds of “smart” optimizations, including but not limited to, optimizations which are based on geographic location, ping speed, and details provided by the user server.

Next, the file is logically divided into small chunks, each of which is preferably an optimal size for a single “send” during a TCP/IP session. The size of the logical chunks into which the file is to be divided is preferably determined by the peer device which is downloading the file. Optionally, the logical chunks may be any requested size. The peer device which is downloading the file then preferably requests specific chunks by specifying the physical block in the file, according to the offset of the block start and the length of the chunk. The chunk is then more preferably sent to the downloading peer device in a separate message.

The client module then starts sending requests for chunks to “uploaders”, which is the peer device acting as the “server”, by providing the file to be downloaded by the peer device which is requesting the file. Each uploader, upon receiving such a request, optionally and preferably first signs the file to compare the result to an original signature, to be certain that the file was not changed. The original signature is preferably stored in a special database at the uploader peer device. Each file is optionally and preferably stored inside one of a plurality of “shared” folders, and is more preferably signed by the client module at the initial moment of storage. This signature alone, optionally and preferably with file details, more preferably automatically obtained from the file, are sent to central database accessed through the central server of FIG. 1. Most preferably, this information is also stored in the local client database.

When a request for downloading a file is made, the “downloader”, or peer device which wishes to download the file, sends the file signature of the requested file to an “uploader” peer device. The “uploader” then examines the local database containing the file with this particular signature. The check of file integrity is preferably performed by comparing the transmitted file signature with the locally stored file signature. This “local” database is more preferably required to remain synchronized with the central database. Such synchronization is more preferably performed by performing periodical checks for changes in “shared” folders, for example to determine whether a file was removed and/or a new file was added. Information about those changes is preferably returned to the central database as soon as the peer device becomes connected to the system of FIG. 1.

Optionally and more preferably, a plurality of uploaders are balanced. Most preferably, the load balancing is performed such that the uploader with a better connection receives more requests to receive a “chunk”.

During the process of actually downloading the file, optionally and most preferably, additional performance optimization is performed. Also optionally, the actual upload performance of each “uploader” is used to do such an optimization. During the downloading process, the throughput of each uploader peer device can optionally be measured. Such throughput is measured according to the amount of data chunks which are sent in a particular period of time. These statistics are then preferably used to determine the dynamically change the particular selected “uploaders”, for example in order to stop using slower peer devices for uploading and to preferentially select more rapid uploaders.

If the connection between the client module (on the user device) and one of the “uploaders” is broken, optionally and preferably the client module attempts to reestablish the connection with another peer device from the list of such devices which hold the file. If there is no other peer device in the list, optionally the download is considered to be “queued” and more preferably resumes from the initial downloading stage, most preferably after a given period of time has elapsed.

After all of the chunks of the file are downloaded, they are assembled into a target file. The file signature is then preferably determined again in order to ensure that the file was not corrupted during the downloading process.

According to preferred embodiments of the present invention, client module 14 also optionally and preferably features bandwidth control, such that the user is able to determine the amount of bandwidth and/or computational resources which are consumed by client module 14.

Client module 14 can also optionally and preferably play digital media files (audio/video) and show pictures using an associated Media Player (not shown).

Also, client module 14 optionally features a chat functionality, to enable the user to chat with other users online through network 18. Client module 14 is preferably aware of the worldwide IRC protocol. Such chat functionality preferably also enables users to communicate with the exchange of voice data through a VoiceOverIP function. In addition, system 10 preferably also enables file links to be sent between client module 14 through the chat functionality, such that the user is more preferably able to paste in chat window, or GUI (graphical user interface) provided by client module 14, a special File Link, which the receiving user can then “click on” or otherwise select to automatically download the file.

According to optional but preferred features of system 10, client module 14 is able to send messages between peer devices 12 for instant messaging. Messages may also optionally contain simple text, links for retrieving files and any other digital data attached. Messages can be sent directly to the recipient user at the recipient peer device 12, or alternatively through a server located at central location authority 16.

Client module 14 optionally and more preferably features a media manager for organizing media files in different folders; and constructing play lists for playing those files in the associated, previously described Media Player.

Furthermore, client module 14 more preferably enables the user to be notified whenever new examples of certain types of media content become listed through centralized database 20. For example, client module 14 can ask user server 24 to provide any file content on a specific subject at any time. For example, if a user is maintaining a Web server which serves Jazz music, the user can install client module 14 on the Web server to transform the Web server into a peer device 12 for system 10. The user could then ask for any content related to Jazz to be provided automatically. The user could even preferably update Web pages served by the Web server automatically, for example by using the script mechanism of client module 14.

According to optional but preferred embodiments of the present invention, system 10 also features an information security system for encrypting and/or authenticating classified data defined by the user before transmitting such data from peer device 12 of the user. Client module 14 is preferably able to manage renewed sets of security keys which are downloaded from central location authority, and particularly from a server which acts as the certificate authority of system 10.

According to an alternative implementation of the system of FIG. 1, the system is implemented without central location authority. For example, client module 14 can optionally interact with other peer devices 12 for basic file transfer operations without servers. Alternatively, a plurality of “virtual servers” may be implemented, which are actually clients or other peer devices 12. These virtual servers can optionally serve as “local” servers for a limited amount of users, thereby creating micro user communities with substantially no limit to the number of peer devices 12 contained within the overall system.

Other peer device 12 functions may optionally include a peer driver for connecting any electronic device to system 10. Such a peer driver would enable these devices to communicate with other peer devices 12 through network 18. For example, a user may optionally connect a printer to system 10 for enabling remote printing. Alternatively or additionally, a peer device 12 could optionally be designated as a redirection peer, for example in order to enable the user to automatically backup files to other mirrored peer devices 12. The shared data can still be accessed from the redirection point or redirection peer.

Also additionally or alternatively, a plurality of peer devices 12 connected through system 10 could optionally be used to perform complicated calculations and processing tasks, preferably by creating a processing plug-in to client module 14.

While the invention has been described with respect to a limited number of embodiments, it will be appreciated that many variations, modifications and other applications of the invention may be made.

What is claimed is:

1. A method for file transfer between a plurality of peer devices connected through a network, the method comprising the stages of:
(a) associating each peer device with a unique peer device identifier;
(b) associating each file with a unique file identifier;
(c) requesting a particular file by the peer device according to said unique file identifier;
(d) controlling access by a particular peer device to the network according to said unique peer device identifier; and
(e) controlling access of said file to the network according to said unique file identifier.

2. The method of claim 1, wherein stage (e) includes the stage of blocking an unauthorized file from the network.

3. The method of claim 1, wherein stage (d) includes the stage of registering a new peer device for a user on the network.

4. The method of claim 3, wherein stage (d) includes the stage of charging said user for each file transfer according to said unique peer device identifier and according to said unique file identifier.

5. The method of claim 1, further comprising the stages of:
(e) requesting a file according to a file identifier from the peer device.

6. The method of claim 5, wherein stage (e) further comprises the stages of:
(i) identifying a plurality of peer devices storing said file;
(ii) selecting a peer device for downloading said file according to at least one peer device criterion; and
(iii) downloading said file from said peer device.

7. The method of claim 6, wherein said file is signed before being downloaded in order to verify that the correct file is completely and correctly received.

8. The method of claim 6, wherein stage (iii) further comprises the stages of:
(1) dividing said file into a plurality of chunks; and
(2) downloading each chunk from said peer device.

9. The method of claim 8, wherein if said connection to said peer device is broken, a connection to a different peer device is established in order to download the next chunk.

10. The method of claim 6, wherein stage (ii) further comprises the stage of selecting a plurality of peer devices for downloading, such that stage (iii) is performed with said plurality of peer devices.

11. The method of claims 6 or 10, wherein each peer device selected for downloading is connected to the same ISP (Internet Service Provider) as a requesting peer device, said requesting peer device requesting said particular file for downloading.

12. The method of any of claims 1-11, wherein said unique file identifier is a unique file pointer, featuring at least a file signature for said particular file.

13. The method of claim 12, wherein said file signature is compared to an original signature stored at said peer device for downloading to determine whether said particular file has been altered.

14. The method of either of claims 12 or 13, further comprising:
after downloading said particular file by said requesting peer device, comparing said file signature to said original signature to determine whether said particular file has been altered.

15. A system for controlled peer-to-peer file transfer for a user through a network, comprising:
(a) a plurality of peer devices connected to the network, each peer device having a unique peer identifier; and
(b) a central authority for holding a list of available files and for storing said peer identifiers, said central authority receiving a request for a file from a peer device and determining whether said peer device should receive said file, such that if said peer device should receive said file, said central authority sends a peer identifier of a peer device storing said file to said requesting peer device.

16. The system of claim 15, further comprising:
(c) a centralized database at said central authority for holding said list of available files and said peer identifiers; and
(d) a plurality of slice servers for serving a portion of said list of available files and said peer identifiers to each requesting peer device.

17. The system of claims 15 or 16, further comprising a search engine for searching through said list of available files according to a request from a requesting peer device.

18. The system of any of claims 15-17, further comprising a business server for charging the user for each file transfer by said peer device.

19. The system of claim 18, wherein said business server further determines a scope of services for being provided to a requesting peer device.

20. The system of claims 18 or 19, wherein said business server further determines whether at least one search result from said search engine is sent to said requesting peer device.

21. The system of any of claims 15-20, further comprising a local database for storing at least said particular file at said peer device for downloading, wherein said local database is synchronized with said centralized database.
